(19) United States
(12) Patent Application Publication
(10) Pub. No.: US 2010/0064806 A1
(43) Pub. Date: Mar. 18, 2010

(54) ANGULAR VELOCITY SENSOR ELEMENT, ANGULAR VELOCITY SENSOR, AND ELECTRONIC APPARATUS

(75) Inventor: Teruo Inaguma, Miyagi (JP)

Correspondence Address: K&L Gates LLP, P. O. BOX 1135, CHICAGO, IL, 60690, US

(73) Assignee: SONY CORPORATION, TOKYO (JP)

(21) Appl. No.: 12/559,965

(22) Filed: Sep. 15, 2009

(30) Foreign Application Priority Data
Sep. 17, 2008 (JP) P2008-238344

(51) Int. Cl. G01C 19/56

(52) U.S. Cl. 73/504.12

(57) ABSTRACT

An angular velocity sensor element includes a main body having three vibrator portions including a vibrator portion that is vibrated in a first phase and a vibrator portion that is vibrated in a second phase opposite to the first phase, a first detecting piezoelectric layer that detects a vibration of the vibrator portion vibrated in the first phase and is formed on the vibrator portion vibrated in the first phase, a second detecting piezoelectric layer that detects a vibration of the vibrator portion vibrated in the first phase and is formed on the vibrator portion vibrated in the first phase and disposed away from the first detecting piezoelectric layer, and a driving piezoelectric layer that vibrates the vibrator portion that is vibrated in the second phase and is formed on the vibrator portion vibrated in the second phase and disposed away from the first and second detecting piezoelectric layer.

### CROSS REFERENCES TO RELATED APPLICATIONS

The present application claims priority to Japanese Priority Patent Application JP 2008-238344 filed in the Japan Patent Office on Sep. 17, 2008, the entire content of which is hereby incorporated by reference.

### BACKGROUND

The present application relates to an angular velocity sensor element and an angular velocity sensor used for, for example, a hand jiggle detection when a video camera is used, an operation detection in a virtual reality apparatus, and a direction detection in a car navigation system, and to an electronic apparatus equipped with an angular velocity sensor.

In related art, as a consumer angular velocity sensor, there is being widely used a so-called vibrating gyro sensor that detects an angular velocity by detecting Coriolis force generated due to an influence of an angular velocity by using a piezoelectric element or the like with a vibrator being vibrated at a predetermined resonant frequency. A vibrating gyro sensor has advantages in its simple structure, short start-up time, and low-cost manufacturability. Electronic apparatuses such as a video camera, a virtual reality apparatus, and a car navigation system are each equipped with a vibrating gyro sensor, which is used as a sensor for, for example, a hand jiggle detection, an operation detection, and a direction detection, respectively.

With decreasing size and increasing performance of an electronic apparatus equipped with a vibrating gyro sensor, there is a demand for a vibrating gyro sensor to be reduced in size and enhanced in performance. Specifically, for example, for implementing a multifunctional electronic apparatus, a vibrating gyro sensor is required to be mounted on a single integrated substrate in combination with various sensors used for other purposes, to realize the miniaturization. To realize the miniaturization of a vibrating gyro sensor, a processing technique called MEMS (Micro Electro Mechanical Systems) is generally used. In the MEMS, a structure is formed by using a mono-crystalline substrate made of silicon (Si) or the like, a photolithography technique, and a thin-film formation process used in a field of the semiconductor manufacture.

Japanese Patent Application Laid-open No. 2005-241382 (hereinafter, referred to as Patent Document 1) discloses a cantilever angular velocity sensor in which a drive electrode for excitation and a detection electrode for an angular velocity detection are formed on one surface of a single arm portion that constitutes a vibrator through a piezoelectric layer. In the cantilever angular velocity sensor, the arm portion is excited in a direction perpendicular to the formation surface of the piezoelectric layer, and a vibration component parallel to the formation surface of the piezoelectric layer is defined as a detection direction of the angular velocity.

Further, Japanese Patent Application Laid-open No. 2006-17569 (hereinafter, referred to as Patent Document 2) discloses a tuning fork type angular velocity sensor in which a drive electrode for excitation and a detection electrode for an angular velocity detection are formed on one surface of each of two arm portions that constitute a vibrator through a piezoelectric layer. In the tuning fork type angular velocity sensor, the arm portions are excited in a direction parallel to the formation surface of the piezoelectric layer, and a vibration component in a direction perpendicular to the formation surface of the piezoelectric layer is defined as a detection direction of the angular velocity.

### SUMMARY

However, in the angular velocity sensor disclosed in Patent Document 1, the drive electrode and the detection electrode are formed on one continuous piezoelectric layer. The drive electrode is subjected to voltage application from outside to vibrate the piezoelectric layer, and the detection electrode is subjected to vibration of the piezoelectric layer to obtain a voltage. In other words, a piezoelectric effect and an inverse piezoelectric effect are generated on the single piezoelectric layer at the same time. Accordingly, the both interfere with each other, which may undesirably affect detection accuracy of the angular velocity. In addition, the voltage applied to the drive electrode may leak into the detection electrode, namely, a leak voltage may be generated. In particular, in a case where uneven leak voltages leak into right and left detection electrodes, a power supply rejection ratio (PSRR) may deteriorate. It should be noted that the power supply rejection ratio refers to a rate of change in detection sensitivity at a time when a power voltage is varied. The smaller a value of the ratio, the less likely an influence of a disturbance is to be given.

In addition, the angular velocity sensor disclosed in Patent Document 2 is formed so that the arms are excited in parallel to the formation surface of the piezoelectric layer. Therefore, the center of rigidity of vibration by the piezoelectric layer is deviated from the center of gravity of the vibrator. Accordingly, if a drive frequency drifts due to superimposition of disturbance signals, a vibration surface of the vibrator in a resonated state easily deviates. As a result, an output of detection is varied in a state where the angular velocity is not generated, which may increase a noise undesirably.

In view of the above-mentioned circumstances, it is desirable to provide an angular velocity sensor having stable sensitivity characteristics and a low power supply rejection ratio.

According to an embodiment, there is provided an angular velocity sensor element including a main body, a first detecting piezoelectric layer, a second detecting piezoelectric layer, and a driving piezoelectric layer.

The main body has three vibrator portions including a vibrator portion that is vibrated in a first phase and a vibrator portion that is vibrated in a second phase opposite to the first phase.

The first detecting piezoelectric layer detects a vibration of the vibrator portion that is vibrated in the first phase, and the first detecting piezoelectric layer is formed on the vibrator portion that is vibrated in the first phase.

The second detecting piezoelectric layer detects a vibration of the vibrator portion that is vibrated in the first phase, and the second detecting piezoelectric layer is formed on the vibrator portion that is vibrated in the first phase and disposed away from the first detecting piezoelectric layer.

The driving piezoelectric layer vibrates the vibrator portion that is vibrated in the second phase, and the driving piezoelectric layer is formed on the vibrator portion that is vibrated in the second phase and disposed away from the first detecting piezoelectric layer and the second detecting piezoelectric layer.

Because the first and second detecting piezoelectric layers are disposed away from each other and away from the driving piezoelectric layer, a piezoelectric effect and an inverse piezoelectric effect are not generated at the same time, and are prevented from interfering with each other. In addition, a leak voltage is not generated between a drive electrode and a detection electrode, and therefore a power supply rejection ratio (PSRR) can be lowered.

The three vibrator portions may be constituted of a first vibrator portion, a second vibrator portion, and a third vibrator portion that are structured as follows.

The first vibrator portion and the second vibrator portion are vibrated in the second phase.

The third vibrator portion is vibrated in the first phase and is disposed between the first vibrator portion and the second vibrator portion.

With the structure in which the third vibrator portion on which the first and second detecting piezoelectric layers are formed is disposed between the first and second vibrator portions on which the driving piezoelectric layer is formed, it is possible to detect a Coriolis force generated in the third vibrator portion by the first and second detecting piezoelectric layers when an angular velocity is applied to the angular velocity sensor element.

The angular velocity sensor element may further include a first electrode and a second electrode that are structured as follows.

The first electrode includes a first upper electrode layer and a first lower electrode layer that are opposed to each other while sandwiching the first detecting piezoelectric layer.

The second electrode includes a second upper electrode layer and a second lower electrode layer that are opposed to each other while sandwiching the second detecting piezoelectric layer, and the second electrode is disposed away from the first electrode.

With the structure in which the first electrode and the second electrode are disposed away from each other, it is possible to prevent a leak current from being generated between the first electrode and the second electrode.

In the angular velocity sensor, the main body may include a fixation portion, a connection portion, and a support portion that are structured as follows.

The fixation portion has a width in a first direction and a thickness in a second direction perpendicular to the first direction and is fixed to a mounting board.

The connection portion connects the three vibrator portions to one another.

The support portion is connected between the fixation portion and the connection portion and has a thickness smaller than the thickness of the fixation portion and a width smaller than the width of the fixation portion.

The angular velocity sensor element includes the support portion whose width is smaller than the fixation portion between the fixation portion and the vibrator portions, and thus can prevent the vibration of the vibrator portions from leaking to the fixation portion or the mounting board. As a result, it is possible to prevent variation in vibration of the vibrator portions due to the leakage of the vibration.

The three vibrator portions may be constituted of a first vibrator portion, a second vibrator portion, and a third vibrator portion.

The first vibrator portion and the second vibrator portion are vibrated in the first phase.

The third vibrator portion is vibrated in the second phase and disposed between the first and second vibrator portions.

According to another embodiment, there is provided an angular velocity sensor including an angular velocity sensor element and a circuit board.

The angular velocity sensor element includes a main body having three vibrator portions including a vibrator portion that is vibrated in a first phase and a vibrator portion that is vibrated in a second phase opposite to the first phase, a first detecting piezoelectric layer to detect a vibration of the vibrator portion that is vibrated in the first phase, a second detecting piezoelectric layer to detect a vibration of the vibrator portion that is vibrated in the first phase, and a driving piezoelectric layer to vibrate the vibrator portion that is vibrated in the second phase, the first detecting piezoelectric layer being formed on the vibrator portion that is vibrated in the first phase, the second detecting piezoelectric layer being formed on the vibrator portion that is vibrated in the first phase and disposed away from the first detecting piezoelectric layer, the driving piezoelectric layer being formed on the vibrator portion that is vibrated in the second phase and disposed away from the first detecting piezoelectric layer and the second detecting piezoelectric layer.

The circuit board is provided with the angular velocity sensor element mounted thereon.

According to another embodiment, there is provided an electronic apparatus equipped with an angular velocity sensor, the angular velocity sensor includes an angular velocity sensor element and a circuit board.

The angular velocity sensor element includes a main body having three vibrator portions including a vibrator portion that is vibrated in a first phase and a vibrator portion that is vibrated in a second phase opposite to the first phase, a first detecting piezoelectric layer to detect a vibration of the vibrator portion that is vibrated in the first phase, a second detecting piezoelectric layer to detect a vibration of the vibrator portion that is vibrated in the first phase, and a driving piezoelectric layer to vibrate the vibrator portion that is vibrated in the second phase, the first detecting piezoelectric layer being formed on the vibrator portion that is vibrated in the first phase, the second detecting piezoelectric layer being formed on the vibrator portion that is vibrated in the first phase and disposed away from the first detecting piezoelectric layer, the driving piezoelectric layer being formed on the vibrator portion that is vibrated in the second phase and disposed away from the first detecting piezoelectric layer and the second detecting piezoelectric layer.

The circuit board is provided with the angular velocity sensor element mounted thereon.

As described above, according to the present application, it is possible to provide the angular velocity sensor having stable sensitivity characteristics and the lower PSRR.

Additional features and advantages are described herein, and will be apparent from the following Detailed Description and the figures.

### BRIEF DESCRIPTION OF THE FIGURES

FIG. 1 is a perspective view showing an angular velocity sensor according to a first embodiment;

FIG. 2 is an exploded perspective view showing the angular velocity sensor element;

FIG. 3 is a plan view showing the angular velocity sensor;

FIG. 4 is a cross-sectional view showing an X-Z plane of each of arms;

FIG. 5 is a schematic diagram showing an electrical connection between the angular velocity sensor element and a control circuit;

FIG. 6 are schematic diagrams each showing a principle of angular velocity detection in the angular velocity sensor element;

FIG. 7 is a plan view showing an angular velocity sensor element according to a second embodiment of the present application;

FIG. 8 is a cross-sectional view showing an X-Z plane of each of arms;

FIG. 9 is a plan view showing an angular velocity sensor element according to Comparative example;

FIG. 10 is a plan view showing an angular velocity sensor element according to another Comparative example;

FIG. 11 is a graph in which a relationship between a difference in leak voltages and a Null voltage is plotted;

FIG. 12 is a graph in which a leak voltage obtained for each sample is plotted;

FIG. 13 is a graph in which a relationship between a Null voltage and a PSRR is plotted;

FIG. 14 is a graph in which a PSRR obtained for each sample is plotted; and

FIG. 15 is a graph in which a sensitivity variation rate obtained for each sample is plotted.

### DETAILED DESCRIPTION

The present application will be described with reference to the drawings according to an embodiment.

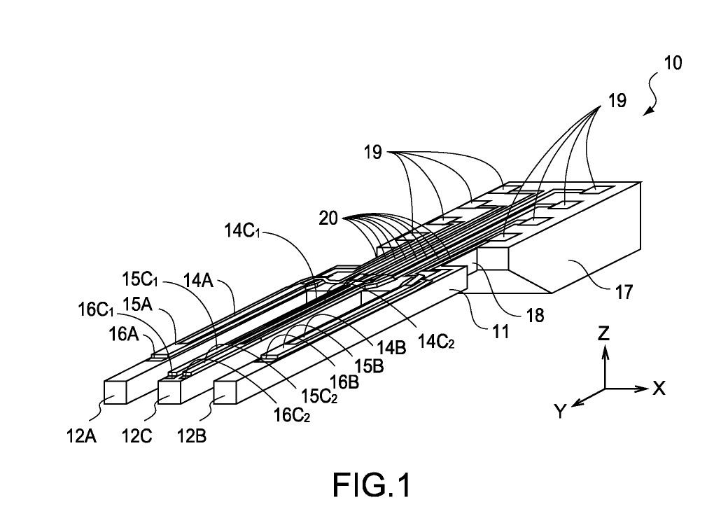

FIG. 1 is a perspective view showing an angular velocity sensor element 10.

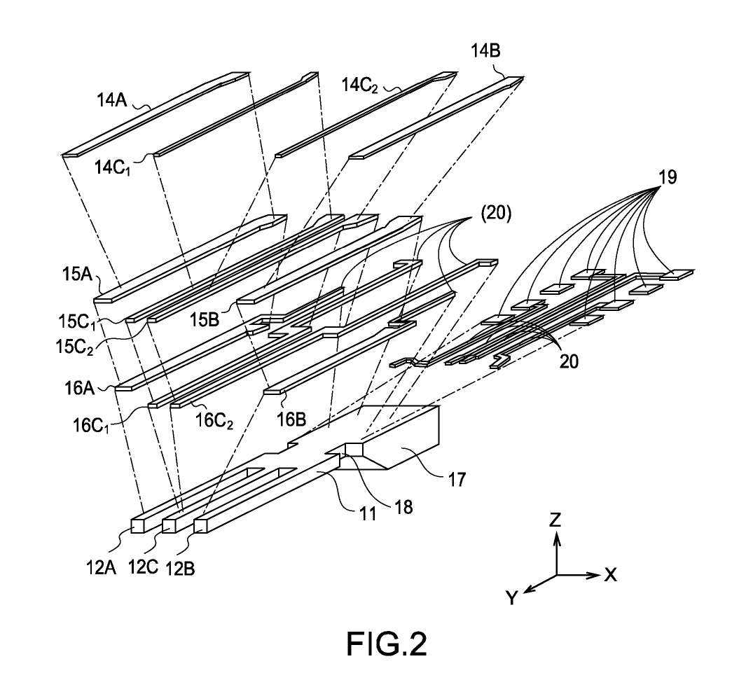

FIG. 2 is an exploded perspective view showing the angular velocity sensor element 10.

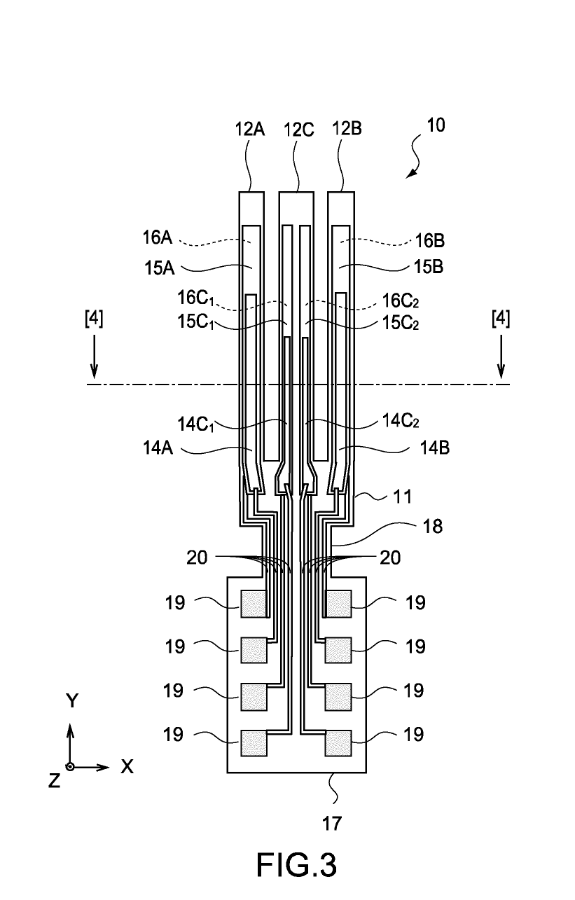

FIG. 3 is a plan view showing the angular velocity sensor element 10.

The angular velocity sensor element 10 according to a first embodiment includes a connection portion 11, three arms 12 (12A, 12B, and 12C) which are extended from the connection portion 11 in the same direction and each of which has a quadrangular cross section. The three arms 12 are aligned in a row side by side (in a plane). The direction in which the three arms 12 are aligned is set as an X-axis direction, and the direction in which the three arms 12 are extended is set as a Y-axis direction. A direction perpendicular to the X-axis direction and the Y-axis direction is set as a Z-axis direction. The same holds true for subsequent drawings.

The connection portion 11 and the arms 12 are cut out into a predetermined shape from a mono-crystalline substrate having no piezoelectric characteristics, such as a silicon wafer, and various lead wiring portions, a drive portion, or a detection portion (described later) is formed, thereby forming the angular velocity sensor element 10. It should be noted that the angular velocity sensor element 10 has a size of 0.5 mm in the X-axis direction, 3 mm in the Y-axis direction, and 0.3 mm in the z-axis direction approximately. The arms 12 each have a length of 1.8 to 1.9 mm (Y-axis direction) and a width of 0.1 mm (X-axis direction).

The arms 12A to 12C constitute a vibrator of the angular velocity sensor element 10. In the angular velocity sensor element 10 according to this embodiment, the arms 12A to 12C have the same arm length, width, and thickness, but they are not limited thereto. Among the arms 12A to 12C, the arms disposed on outer sides are expressed as outer arms 12A and 12B, and the arm disposed in the center is expressed as a center arm 12C. Hereinafter, structures provided to the arms 12 (12A, 12B, and 12C) are denoted by corresponding symbols (A, B, and C), respectively.

The angular velocity sensor element 10 includes a fixation portion 17 and a support portion 18. The fixation portion 17 fixes the angular velocity sensor element 10 to a mounting board (not shown). The support portion 18 supports the fixation portion 17 and the connection portion 11.

The support portion 18 is formed to have a width (X-axis direction) smaller than the connection portion 11 and the fixation portion 17. By adjusting the width of the support portion 18, vibration transmitted from the arms 12 to the fixation portion is attenuated, with the result that the vibration of the arms 12 can be prevented from leaking to the fixation portion 17 and the mounting board fixed with the fixation portion 17.

The fixation portion 17 can physically fix and electrically connect the angular velocity sensor element 10 to the mounting board.

As shown in FIG. 2 and FIG. 3, on the connection portion 11 of the angular velocity sensor element 10, external connection terminals 19 are formed, and each upper electrode layer (14A, 14B, 14C₁, and 14C₂) and each lower electrode layer (16A, 16B, 16C₁, and 16C₂) are connected to the external connection terminals 19 via wirings 20.

The angular velocity sensor element 10 according to this embodiment is mounted on the mounting board (circuit board) (not shown) provided with a control unit 30 (described later) with a flip chip structure. The angular velocity sensor element 10 and the mounting board are electrically and mechanically connected to each other via the external connection terminals 19 of the angular velocity sensor element 10, an electrode pattern (land) on the mounting board, and a bump (gold bump) formed therebetween. The mounting method is not limited to this, and the structures of the external connection terminals or the wirings are not limited to those shown in the figures. In addition, before the mounting, on piezoelectric functional bodies 13 (13A, 13B, 13C₁, and 13C₂) and the wirings 20 of the angular velocity sensor element 10, a protective layer (not shown) is formed.

The angular velocity sensor element 10 and the mounting board constitute an angular velocity sensor, which is packaged as a sensor module, for example. Further, the angular velocity sensor element is connected to a control circuit (not shown) of an electronic apparatus via the mounting board. Examples of the electronic apparatus include a digital camera, a personal digital assistant, a portable game machine, and a handheld display apparatus.

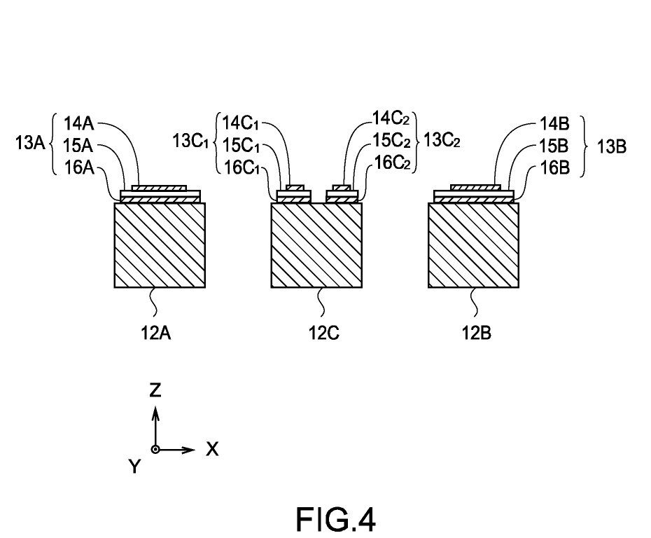

FIG. 4 is a cross-sectional view showing an X-Z plane of each of the arms 12A to 12C.

FIG. 4 shows a cross section taken along the dash-dotted line [4]-[4] of FIG. 3.

On one surface of the outer arms 12A and 12B, the piezoelectric functional bodies 13A and 13B are formed, respectively. The piezoelectric functional bodies 13A and 13B are constituted of the lower electrode layers 16A and 16B formed on the outer arms 12A and 12B, the piezoelectric layers 15A and 15B formed on the lower electrode layers 16A and 16B, and the upper electrode layers 14A and 14B formed on the piezoelectric layers 15A and 15B, respectively.

On the other hand, on one surface of the center arm 12C, the two piezoelectric functional bodies 13C (13C₁ and 13C₂) are formed. The piezoelectric functional bodies 13C (13C₁ and 13C₂) are constituted of the lower electrode layers 16C (16C₁ and 16C₂) formed on the center arm 12C, the piezoelectric layers 15C (15C₁ and 15C₂) formed on the lower electrode layers 16C, and the upper electrode layers 14C (14C₁ and 14C₂) formed on the piezoelectric layers 15C. The piezoelectric functional bodies 13C₁ and 13C₂ are formed at positions that are symmetric with respect to a centerline in the Y-axis direction on the one surface of the center arm 12C.

The piezoelectric functional body 13C₁ formed by layering the lower electrode layer 16C₁, the piezoelectric layer 15C₁, and the upper electrode layer 14C₁ and the piezoelectric functional body 13C₂ formed by layering the lower electrode layer 16C₂, the piezoelectric layer 15C₂, and the upper electrode layer 14C₂ are separated.

The lower electrode layers 16A to 16C are constituted of layered films of Ti (titanium) and Pt (Platinum) formed on a Si substrate by the sputtering method, and provided on the arms 12A to 12C, respectively. The piezoelectric layers 15A to 15C are formed by performing RF sputtering on a target of, e.g., PZT (lead zirconate titanate) in an oxygen atmosphere. The upper electrode layers 14A to 14C are formed by sputtering, for example, Pt on the piezoelectric layers 15A to 15C. In addition, the photolithography technique is used to perform patterning into each electrode shape, and an etching or lift-off process is carried out, thereby forming various patterns.

A composition of PZT can be expressed by Pb₁+_{X}(Zr_{Y}Ti_{1-Y})O₃+_{X}. Specifically, for example, in the composition of PZT, X can be set to 0 or more and 0.3 or less and Y can be set to 0 or more and 0.55 or less. A thickness of PZT in this case can be set to 400 nm or more and 1000 nm or less, for example.

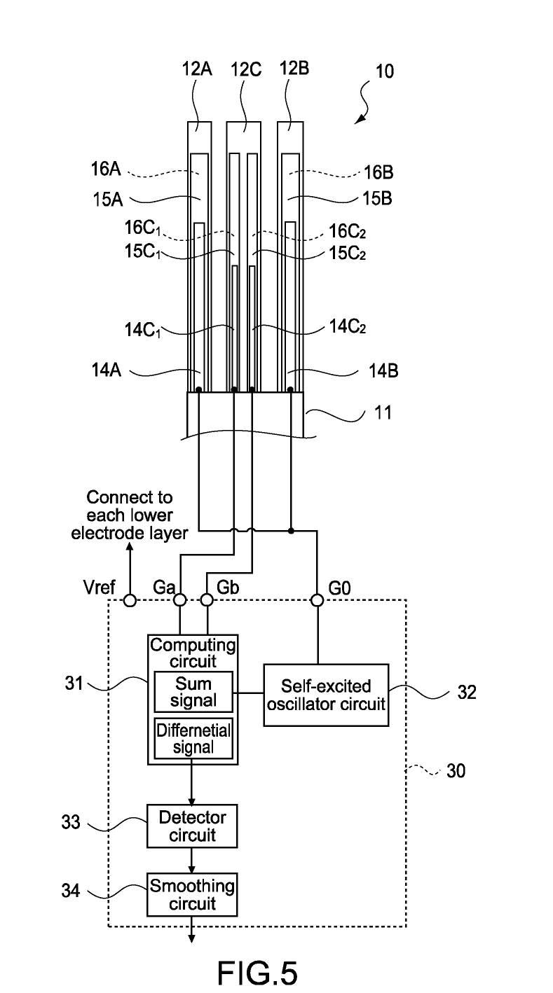

FIG. 5 is a schematic diagram showing an electrical connection between the angular velocity sensor element 10 and a control circuit.

As shown in FIG. 5, the angular velocity sensor element 10 is connected to the control unit 30 constituted of an IC circuit element and the like. The control unit 30 is provided on the mounting board described above, for example.

The control unit 30 is constituted of a computing circuit 31, a self-excited oscillator circuit 32, a detector circuit 33, and a smoothing circuit 34, and includes a G0 terminal, a Ga terminal, a Gb terminal, and a Vref terminal. The connections and functions of the respective circuits will be described later.

The lower electrode layers 16A to 16C of the angular velocity sensor element 10 are each connected to the Vref terminal of the control unit 30 and function as reference electrodes of the piezoelectric functional bodies 13.

The upper electrode layers 14A and 14B are connected to the G0 terminal of the control unit 30. To the upper electrode layers 14A and 14B, a drive signal generated by the control unit 30 is input. In other words, the upper electrode layers 14A and 14B function as drive electrodes for exciting the arms 12A and 12B.

The upper electrode layer 14C₁ is connected to the Ga terminal of the control unit 30, and the upper electrode layer 14C₂ is connected to the Gb terminal of the control unit 30. Detection signals from the upper electrode layers 14C₁ and 14C₂ are input to the control unit 30, and an angular velocity is detected. In other words, the upper electrode layers 14C₁ and 14C₂ function as detection electrodes for detecting the vibration of the arm 12C.

An operation of the angular velocity sensor element 10 structured as described above will be described.

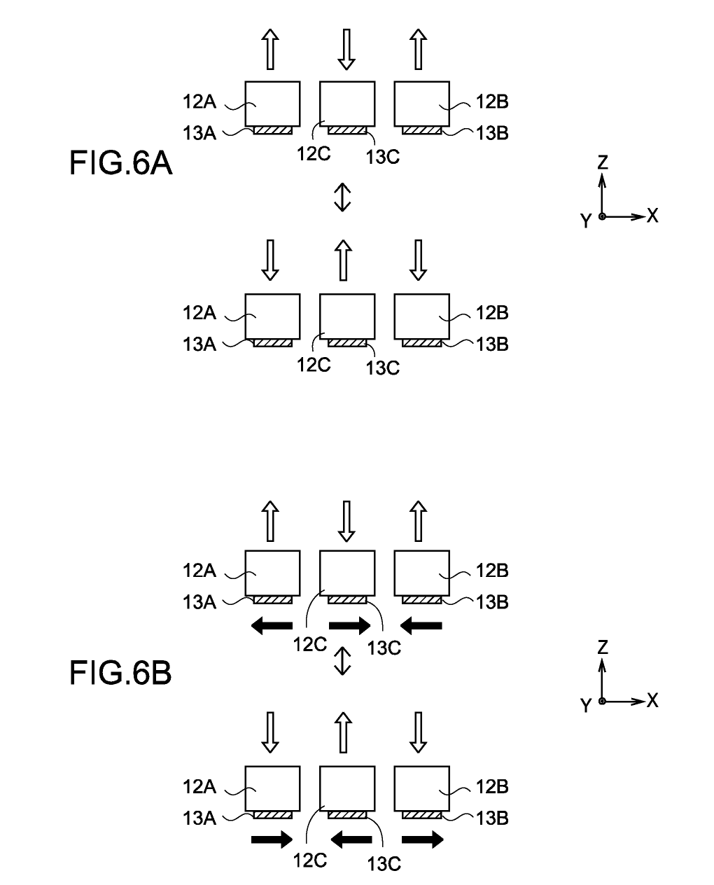

FIGS. 6A and 6B are diagrams each showing a principle of detecting the angular velocity in the angular velocity sensor element 10.

FIG. 6A shows a state where an angular velocity is not applied to the angular velocity sensor element 10.

From the self-excited oscillator circuit 32 of the control unit 30, drive signals in the same phase are respectively input to the upper electrode layers 14A and 14B serving as the drive electrodes. As a result, a voltage is applied to each of the piezoelectric layers 15A and 15B, and the outer arms 12A and 12B are excited by a piezoelectric effect thus obtained and are vibrated in the same phase. A direction in which the outer arms 12A and 12B are vibrated (excited) corresponds to a direction perpendicular to the formation surface of the piezoelectric layers 15A and 15B (Z-axis direction).

When the outer arms 12A and 12B are vibrated, the center arm 12C receives a reaction and therefore is vibrated in a phase opposite to the outer arms 12A and 12B. In FIG. 6A, the vibration directions of the outer arms 12A and 12B and the center arm 12C are indicated by the white arrows.

In this case, because one end of each of the arms 12 is fixed at the connection portion 11, a strain (in the Z-axis direction) is generated in the arms 12 depending on displacement from their initial positions (at which the arms are not vibrated).

Due to the strain, the piezoelectric effects are generated in the piezoelectric layers 15C₁ and 15C₂ of the center arm 12C.

The center arm 12C is strained only in the Z-axis direction, and therefore the piezoelectric effects generated in each of the piezoelectric layers 15C₁ and 15C₂ are almost the same in principle.

By the piezoelectric effects, a current generated by the piezoelectric layer 15C₁ flows in the upper electrode layer 14C₁ (hereinafter, the current is referred to as “detection signal Ga”), and a current generated by the piezoelectric layer 15C₂ flows in the upper electrode layer 14C₂ (hereinafter, the current is referred to as “detection signal Gb”).

The detection signals Ga and Gb are subjected to addition and subtraction in the computing circuit 31, thereby generating a sum signal Ga+Gb and a differential signal Ga−Gb. The sum signal Ga+Gb is fed back to the self-excited oscillator circuit 32, and the differential signal Ga−Gb is output to the smoothing circuit 34 via the detector circuit 33 and is subjected to a processing as an angular velocity signal. In the case where the angular velocity is not applied to the angular velocity sensor element 10, the angular velocity signal is 0 (in principle).

FIG. 6B shows a state where the angular velocity is applied to the angular velocity sensor element 10.

When the angular velocity around the Y axis is applied to the angular velocity sensor element 10 in a state where the arms 12 are vibrated as shown in FIG. 6A, Coriolis force is generated in each of the arms 12. The Coriolis force is generated in a direction (mainly, in the X-axis direction) perpendicular to the vibration direction, i.e., the Z-axis direction in the state shown in FIG. 6A, because the Coriolis force is generated in a direction perpendicular to a direction in which an object moves. That is, the arms 12 receive the sum of a Z-axis component (white arrows) by the excitation and an X-axis component (black arrows) by the Coriolis force, and moves in an elliptical orbit whose major axis is the Z axis.

In this case, because one end of each of the arms 12 is fixed at the connection portion 11, a strain is generated in the arms 12 depending on displacement from their initial positions (at which the arms are not vibrated). Due to the strain, piezoelectric effects are generated in the piezoelectric layer 15C₁ and the piezoelectric layer 15C₂. The center arm 12C is strained in not only the Z-axis direction but also the X-axis direction, so the piezoelectric effects generated in the piezoelectric layer 15C₁ and the piezoelectric layer 15C₂ are different because one is subjected to a compression action and the other is subjected to a stretch action. As a result, different voltages are generated in the upper electrodes 14C₁ (detection signal Ga) and 14C₂ (detection signal Gb).

By those piezoelectric effects, the detection signals Ga and Gb are obtained and input to the control unit 30.

When the computing circuit 31 obtains the differential signal Ga−Gb, a signal in the Z-axis direction is removed (because the piezoelectric effects in the Z-axis direction that affect the piezoelectric layers 15C₁ and 15C₂ are almost the same), and a component in the X-axis direction due to the Coriolis force is mainly extracted. In this way, an angular velocity signal is obtained.

In the angular velocity sensor element 10 according to this embodiment, the drive electrodes (upper electrode layers 14A and 14B) are formed on the outer arms 12A and 12B, respectively, and the detection electrodes (upper electrode layers 14C₁ and 14C₂) are formed on the center arm 12C. In other words, the piezoelectric layers 15A and 15B on the outer arms 12A and 12B are used for the drive, and the piezoelectric layers 15C, and 15C₂ on the center arm 12C are used for the detection. As described above, in the piezoelectric layers used for the drive, the piezoelectric effect is generated, and in the piezoelectric layers used for the detection, the inverse piezoelectric effect is generated. However, because of separation of those piezoelectric layers, no interference occurs therebetween.

In a case where the drive electrodes and the detection electrodes are provided on the same arm, those electrodes are close to each other. Therefore, a voltage applied to each of the drive electrodes leaks to the detection electrodes, which causes leak voltages. In particular, when there is a difference in the leak voltages to the two detection electrodes, a Null voltage (absolute value of a difference between voltages detected by the two detection electrodes in a state where the angular velocity is not applied) may be increased, and a power supply rejection ratio (PSRR) may be increased undesirably. In contrast, when the Null voltage is low, a variation in the detection signals Ga and Gb is reduced. In addition, when the PSRR is low, the variation in the detection signals Ga and Gb is also reduced even if the power supply voltage varies.

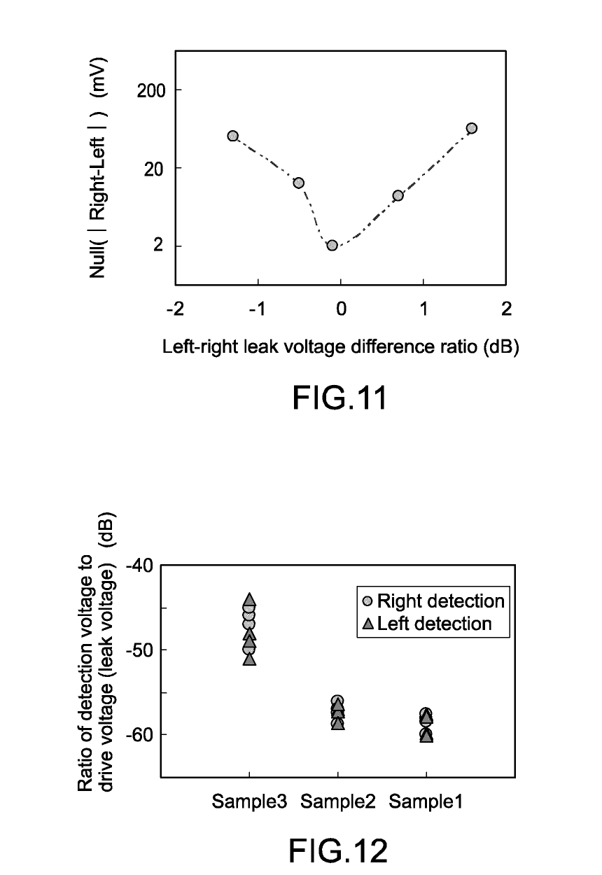

FIG. 11 is a graph in which a relationship between a leak voltage difference between the two detection electrodes and the Null voltage is plotted. As shown in FIG. 11, there is a correlation between the leak voltage difference between the two detection electrodes and the Null voltage.

FIG. 12 is a diagram showing a measurement result of the leak voltage between the two detection electrodes for each of the angular velocity sensor element 10 according to this embodiment (sample 1), an angular velocity sensor element 40 according to Comparative example 1 (sample 2, see Comparative example below), and an angular velocity sensor element 50 according to Comparative example 2 (sample 3, see Comparative example below). It should be noted that a sensor module (angular velocity sensor) obtained by mounting the angular velocity sensor element on a mounting board (circuit board) was used for each sample used in this experiment.

The leak voltage expresses a ratio of a voltage, which is applied to the right and left detection electrodes (between the upper electrode and the lower electrode), to a drive voltage, when the drive voltage of 1.0 V (DC) is applied to the drive electrode.

Right detection and left detection in FIG. 12 each indicate the leak voltage in the right and left detection electrodes when viewed from the fixed portion. The measurement targets are 4 elements extracted at random for each of the right and left detection electrodes.

The measurement result reveals that the angular velocity sensor element 10 according to this embodiment had a smaller leak voltage than the angular velocity sensor elements according to the comparative examples. A difference between the sample 1 and the sample 2 derives from a difference between a structure in which the right and left detection electrodes are provided on the same piezoelectric layer and a structure in which those detection electrodes are provided on different piezoelectric layers. Accordingly, by using the sample 1, it is possible to improve detection accuracy of the angular velocity as compared to the sample 2, because a mutual action between the piezoelectric layers can be avoided.

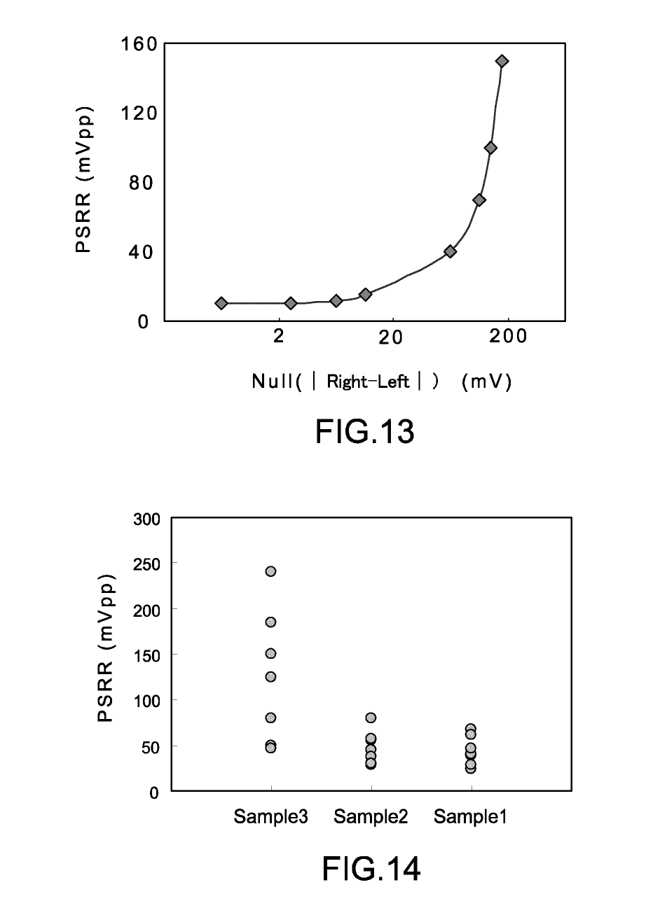

FIG. 13 is a graph in which a relationship between the Null voltage and the PSRR is plotted.

As shown in FIG. 13, with increase in Null voltage, the PSRR increases. The PSRR is an output voltage regulation at a time when a sine wave of ±0.5 V is applied to an input voltage of 3.0 V of the sensor module (angular velocity sensor), and shows characteristics of the angular velocity sensor element.

FIG. 14 is a diagram showing a measurement result of the PSRR of 7 elements extracted at random for each of the angular velocity sensor element 10 according to this embodiment (sample 1), the angular velocity sensor element 40 according to Comparative example 1 (sample 2, see Comparative example below), and the angular velocity sensor element 50 according to Comparative example 2 (sample 3, see Comparative example below).

The measurement result reveals that the angular velocity sensor element 10 according to this embodiment had a smaller PSRR than the angular velocity sensors according to the comparative examples.

Further, in a case where the drive voltage and the detection voltage are formed on the same piezoelectric layer, a minute electric current is generated due to the applied drive voltage and heat generation occurs, with the result that piezoelectric characteristics of the piezoelectric layer may be varied. This may vary the detection signal obtained from the detection electrode formed on the piezoelectric layer.

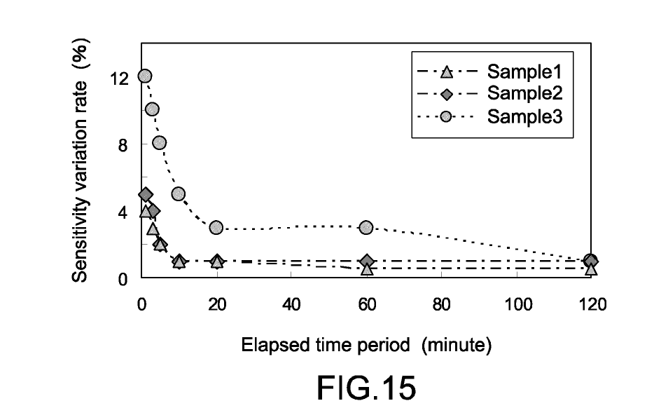

FIG. 15 shows a measurement result of a sensitivity variation rate for each of the angular velocity sensor element 10 according to this embodiment (sample 1), the angular velocity sensor element 40 according to Comparative example 1 (sample 2, see Comparative example below), and the angular velocity sensor element 50 according to Comparative example 2 (sample 3, see Comparative example below).

FIG. 15 shows a graph in which a relationship between an elapsed time period since reflow and the sensitivity variation rate is plotted.

The elapsed time period since reflow refers to a length of time that has elapsed since the angular velocity sensor is mounted on a mounting board by heat through the reflow. The sensitivity variation rate was obtained by dividing a difference between a sensitivity for each elapsed time period since reflow and a sensitivity prior to the reflow by the sensitivity prior to the reflow. A change in sensitivity variation rate with time may be caused by an influence on the detection signal by the heat generation of the piezoelectric layer that is caused by the voltage application from the drive electrode to the piezoelectric layer. Herein, the angular velocity sensor element having sensitivity characteristics and having the detection voltage of 60 mV in a case where the angular velocity is π/2[rad/s] (90[deg/s]) was used for the samples.

The measurement result reveals that the angular velocity sensor element 10 according to this embodiment had a low sensitivity variation rate at any time point in the range of measurement.

As revealed by the measurement result described above, the drive electrode and the detection electrode are formed on the different arms 12 and the piezoelectric functional bodies 13C₁ and 13C₂ are separately formed on the center 12 in the angular velocity sensor element 10 according to this embodiment, with the result that excellent characteristics can be obtained as the angular velocity sensor.

Next, a description will be given on an angular velocity sensor element 60 according to a second embodiment of the present application. In this embodiment and subsequent ones, the same components and the like as the above embodiment are denoted by the same reference numerals or symbols and their descriptions will be omitted. Different points will be mainly described.

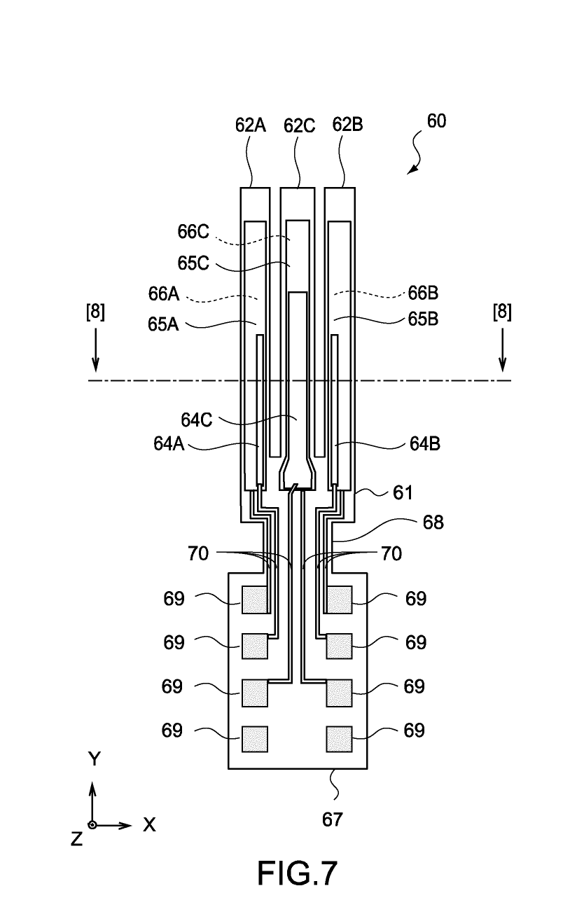

FIG. 7 is a plan view of the angular velocity sensor element 60.

The angular velocity sensor element 60 according to this embodiment includes a connection portion 61 and three arms 62 (62A, 62B, and 62C) which are extended from the connection portion 61 in the same direction and each of which has a quadrangular cross section. The three arms 62 are aligned in a row side by side (in a plane).

In the arms 62A to 62C, arms disposed on outer sides are represented as outer arms 62A and 62B, and an arm disposed at the center is represented as a center arm 62C. Hereinafter, components provided to the arms 62 (62A, 62B, and 62C) are denoted by corresponding symbols (A, B, and C), respectively.

The angular velocity sensor element 60 includes a fixation portion 67 and a support portion 68. The fixation portion 67 fixes the angular velocity sensor element 60 to a mounting board (not shown). The support portion 68 supports the fixation portion 67 and the connection portion 61.

On the connection portion 61 of the angular velocity sensor element 60, external connection terminals 69 are provided, and electrodes are connected to the external connection terminals 69 via wirings 70.

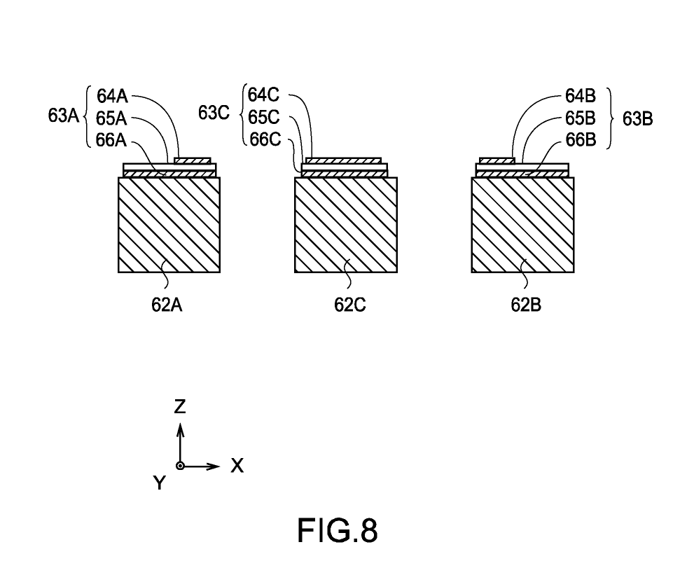

FIG. 8 is a cross-sectional view showing an X-Z plane of each of the arms 62A to 62C.

FIG. 8 shows a cross section taken along the dash-dotted line [8]-[8] of FIG. 7.

On one surface of the outer arms 62A and 62B, piezoelectric functional bodies 63A and 63B are formed, respectively. The piezoelectric functional bodies 63A and 63B are constituted of lower electrode layers 66A and 66B formed on the outer arms 62A and 62B, piezoelectric layers 65A and 65B formed on the lower electrode layers 66A and 66B, and upper electrode layers 64A and 64B formed on the piezoelectric layers 65A and 65B, respectively. The upper electrode layers 64A and 64B are disposed nearer the center arm 62C on the outer arms 62A and 62B, respectively.

On the other hand, on one surface of the center arm 62C, a piezoelectric functional body 63C is formed. The piezoelectric functional body 63C is constituted of a lower electrode layer 66C formed on the center arm 62C, a piezoelectric layer 65C formed on the lower electrode layer 66C, and an upper electrode layer 64C formed on the piezoelectric layer 65C.

The angular velocity sensor element 60 is electrically connected to the control unit 30 like the angular velocity sensor element 10.

The lower electrode layers 66A to 66C of the angular velocity sensor element 60 are each connected to a Vref terminal of the control unit 30 and function as reference electrodes of the piezoelectric functional bodies 63.

The upper electrode layer 64C is connected to the G0 terminal of the control unit 30. A drive signal generated by the control unit 30 is input the upper electrode layer 64C. That is, the upper electrode layer 64C functions as a drive electrode that excites the arm 62C.

The upper electrode layer 64A is connected to the Ga terminal of the control unit 30, and the upper electrode layer 64B is connected to the Gb terminal of the control unit 30. Detection signals from the upper electrode layers 64A and 64B are input to the control unit 30, and the angular velocity is detected. That is, the upper electrode layers 64A and 64B function as detection electrodes that detect vibrations of the arms 62A and 62B, respectively.

An operation of the angular velocity sensor element 60 according to this embodiment will be described.

The operation in a state where an angular velocity is not applied to the angular velocity sensor element 60 is as follows.

From the self-excited oscillator circuit 32 of the control unit 30, a drive signal is input to the upper electrode layer 64C serving as the drive electrode. As a result, a voltage is applied to the piezoelectric layer 65C, and the center arm 62C is excited and vibrated by a piezoelectric effect thus obtained. A direction in which the center arm 62C is vibrated (excited) corresponds to a direction perpendicular to the formation surface of the piezoelectric layer 65C (Z-axis direction).

When the center arm 62C is vibrated, the outer arms 62A and the 62B are subjected to a reaction of the vibration and are vibrated in a phase opposite to the center arm 62C.

Due to the vibration, the piezoelectric effect is generated in the piezoelectric layers 65A and 65B, and thus the detection signals Ga and Gb are obtained.

The operation in a state where an angular velocity is applied to the angular velocity sensor element 60 is as follows.

As described above, when the angular velocity around the Y axis is applied to the angular velocity sensor element 60 in the state where the arms 62 are vibrated, the Coriolis force is generated in each of the arms 62.

A strain of each of the outer arms 62A and 62B due to the Coriolis force causes the piezoelectric effect in the piezoelectric layers 65A and 65B, and the detection signals Ga and Gb are obtained from the upper electrode layers 64A and 64B. Because the upper electrode layers 64A and 64B are disposed nearer the center arm 62C, signal strengths of the detection signals Ga and Gb are different due to stretching deformation in the X-axis direction, and therefore the Coriolis force can be detected.

Those signals are processed by the control unit 30, thereby obtaining the angular velocity applied to the angular velocity sensor element 60.

In this embodiment, the upper electrode layers 64A and 64B used for detection are formed on the piezoelectric layers different from the piezoelectric layer on which the upper electrode layer 64C used for drive is formed. Accordingly, the leak voltage between the electrodes can be prevented, and thus the angular velocity detection can be performed with high accuracy. In addition, the upper electrode layers 64A and 64B used for detection are formed on the different piezoelectric layers. Accordingly, the detection sensitivity of the angular velocity can be further improved.

The present application is not limited to the above embodiments, and may be variously modified without departing from the gist of the present application.

### Comparative Example 1

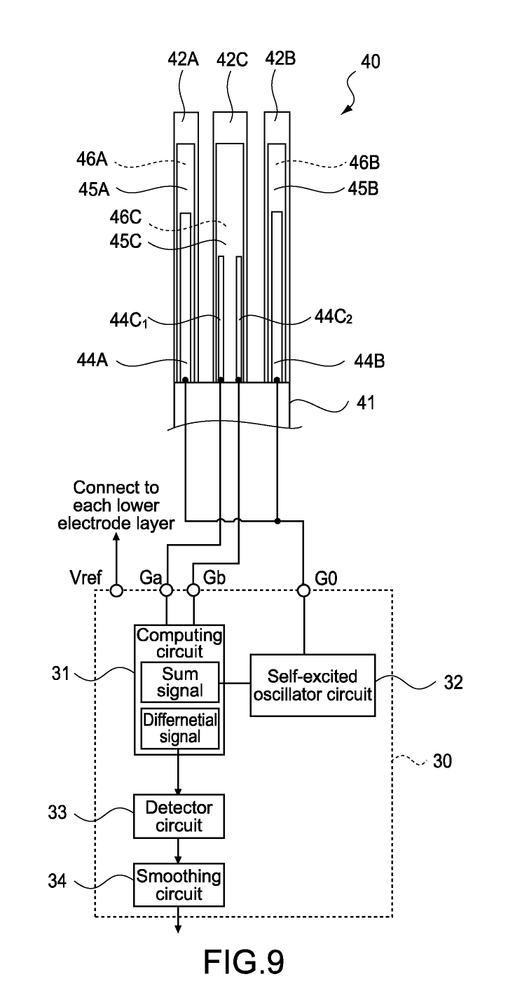

The angular velocity sensor element 40 shown in FIG. 9 was produced as the sample 2.

The angular velocity sensor element 40 according to Comparative example 1 is different from the angular velocity sensor element 10 according to the first embodiment in the structure of the piezoelectric functional body of the center arm.

As shown in FIG. 9, the angular velocity sensor element 40 includes three arms 42A, 42B, and 42C that are extended from a support portion 41 in the same direction. On the arms 42, piezoelectric functional bodies 43 (43A, 43B, and 43C) are formed. The piezoelectric functional bodies 43 (43A and 43B) of the outer arms 42A and 42B are constituted of lower electrode layers 46 (46A and 46B), piezoelectric layers 45 (45A and 45B), and upper electrode layers 44 (44A and 44B) serving as the drive electrodes that are layered in the stated order from the arms 42 side.

The piezoelectric functional body 43C of the center arm 42C is constituted of a lower electrode layer 46C, a piezoelectric layer 45C, and two upper electrode layers 44C (44C1 and 44C2) serving as the detection electrodes, which are layered in the stated order from the arm 42C side.

The other portions (not shown) are the same as those of the angular velocity sensor element 10 according to the first embodiment. The angular velocity sensor element 40 according to Comparative example 1 is different from the angular velocity sensor element 10 according to the first embodiment in that the angular velocity sensor element 40 includes only the single lower electrode layer 46C and the single piezoelectric layer 45C.

### Comparative Example 2

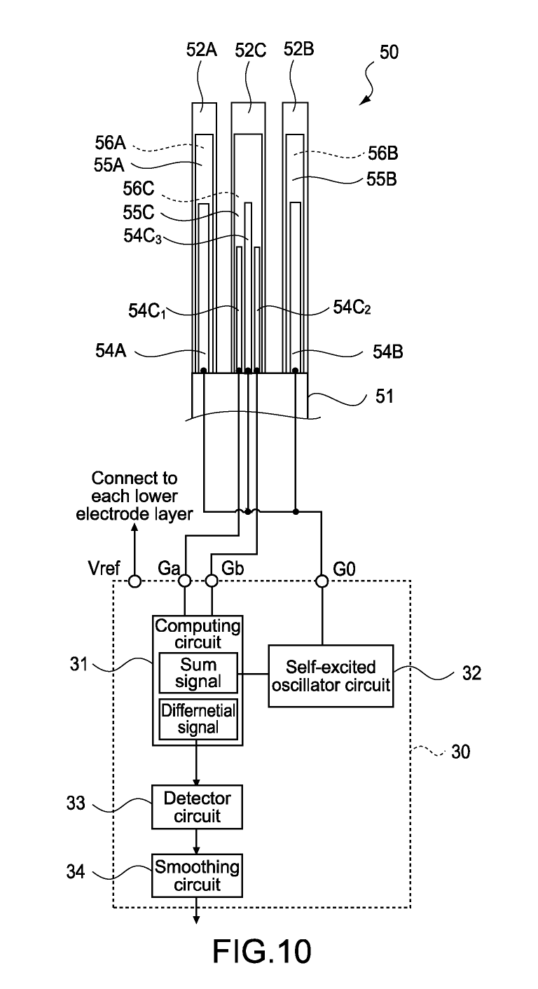

The angular velocity sensor element 50 shown in FIG. 10 was produced as the sample 3.

The angular velocity sensor element 50 according to Comparative example 2 is different from the angular velocity sensor element 10 according to the first embodiment in the structure of the piezoelectric functional body of the center arm.

As shown in FIG. 10, the angular velocity sensor element 50 includes three arms 52A, 52B, and 52C that are extended from a support portion 51 in the same direction. On the arms 52, piezoelectric functional bodies 53 (53A, 53B, and 53C) are formed. The piezoelectric functional bodies 53 (53A and 53B) of the outer arms 52A and 52B are constituted of lower electrode layers 56 (56A and 56B), piezoelectric layers 55 (55A and 55B), and upper electrode layers 54 (54A and 54B) serving as the drive electrodes that are layered in the stated order from the arms 52A and 52B side.

The piezoelectric functional body 53C of the center arm 52C is constituted of a lower electrode layer 56C, a piezoelectric layer 55C, and an upper electrode layer 54C, which are layered in the stated order from the arm 52C side. The upper electrode layer 54C includes two upper electrode layers 54C1 and 54C2 serving as the detection electrodes and an upper electrode layer 54C3 serving as the drive electrode, which is disposed between the upper electrode layers 54C1 and 54C2.

The other portions (not shown) are the same as those of the angular velocity sensor element 10 according to the first embodiment. The angular velocity sensor element 50 according to Comparative example 2 is different from the angular velocity sensor element 10 according to the first embodiment in that the angular velocity sensor element 50 includes only the single lower electrode layer 56C and the single piezoelectric layer 55C and the drive electrode is also provided on the center arm 42C.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The application is claimed as follows:

1. An angular velocity sensor element, comprising:
a main body having three vibrator portions including a vibrator portion that is vibrated in a first phase and a vibrator portion that is vibrated in a second phase opposite to the first phase;
a first detecting piezoelectric layer to detect a vibration of the vibrator portion that is vibrated in the first phase, the first detecting piezoelectric layer being formed on the vibrator portion that is vibrated in the first phase;
a second detecting piezoelectric layer to detect a vibration of the vibrator portion that is vibrated in the first phase, the second detecting piezoelectric layer being formed on the vibrator portion that is vibrated in the first phase and disposed away from the first detecting piezoelectric layer; and
a driving piezoelectric layer to vibrate the vibrator portion that is vibrated in the second phase, the driving piezoelectric layer being formed on the vibrator portion that is vibrated in the second phase and disposed away from the first detecting piezoelectric layer and the second detecting piezoelectric layer.

2. The angular velocity sensor element according claim 1,
wherein the three vibrator portions are constituted of a first vibrator portion and a second vibrator portion that are vibrated in the second phase and a third vibrator portion that is vibrated in the first phase and is disposed between the first vibrator portion and the second vibrator portion.

3. The angular velocity sensor element according to claim 2, further comprising:
a first electrode including a first upper electrode layer and a first lower electrode layer that are opposed to each other while sandwiching the first detecting piezoelectric layer; and
a second electrode including a second upper electrode layer and a second lower electrode layer that are opposed to each other while sandwiching the second detecting piezoelectric layer, the second electrode being disposed away from the first electrode.

4. The angular velocity sensor element according to claim 1,
wherein the main body includes
a fixation portion that has a width in a first direction and a thickness in a second direction perpendicular to the first direction and is fixed to a mounting board,
a connection portion to connect the three vibrator portions to one another, and
a support portion that is connected between the fixation portion and the connection portion and has a thickness smaller than the thickness of the fixation portion and a width smaller than the width of the fixation portion.

5. The angular velocity sensor element according to claim 1,
wherein the three vibrator portions are constituted of a first vibrator portion and a second vibrator portion that are vibrated in the first phase and a third vibrator portion that is vibrated in the second phase and is disposed between the first vibrator portion and the second vibrator portion.

6. An angular velocity sensor, comprising:
an angular velocity sensor element including a main body having three vibrator portions including a vibrator portion that is vibrated in a first phase and a vibrator portion that is vibrated in a second phase opposite to the first phase, a first detecting piezoelectric layer to detect a vibration of the vibrator portion that is vibrated in the first phase, a second detecting piezoelectric layer to detect a vibration of the vibrator portion that is vibrated in the first phase, and a driving piezoelectric layer to vibrate the vibrator portion that is vibrated in the second phase, the first detecting piezoelectric layer being formed on the vibrator portion that is vibrated in the first phase, the second detecting piezoelectric layer being formed on the vibrator portion that is vibrated in the first phase and disposed away from the first detecting piezoelectric layer, the driving piezoelectric layer being formed on the vibrator portion that is vibrated in the second phase and disposed away from the first detecting piezoelectric layer and the second detecting piezoelectric layer; and
a circuit board on which the angular velocity sensor element is mounted.

7. An electronic apparatus equipped with an angular velocity sensor, the angular velocity sensor comprising:
an angular velocity sensor element including a main body having three vibrator portions including a vibrator portion that is vibrated in a first phase and a vibrator portion that is vibrated in a second phase opposite to the first phase, a first detecting piezoelectric layer to detect a vibration of the vibrator portion that is vibrated in the first phase, a second detecting piezoelectric layer to detect a vibration of the vibrator portion that is vibrated in the first phase, and a driving piezoelectric layer to vibrate the vibrator portion that is vibrated in the second phase, the first detecting piezoelectric layer being formed on the vibrator portion that is vibrated in the first phase, the second detecting piezoelectric layer being formed on the vibrator portion that is vibrated in the first phase and disposed away from the first detecting piezoelectric layer, the driving piezoelectric layer being formed on the vibrator portion that is vibrated in the second phase and disposed away from the first detecting piezoelectric layer and the second detecting piezoelectric layer; and
a circuit board on which the angular velocity sensor element is mounted.
